(19) United States
(12) Patent Application Publication
(10) Pub. No.: US 2024/0393676 A1
(43) Pub. Date: Nov. 28, 2024

(54) DESIGN METHOD OF PHOTOMASK STRUCTURE

(71) Applicant: United Microelectronics Corp., Hsinchu (TW)

(72) Inventors: Ming-Hsien Kuo, Tainan City (TW); Chih-Hsien Tang, Taipei City (TW); Song-Yi Lin, Tainan City (TW)

(73) Assignee: United Microelectronics Corp., Hsinchu (TW)

(21) Appl. No.: 18/334,382

(22) Filed: Jun. 14, 2023

(30) Foreign Application Priority Data
May 25, 2023 (TW) 112119466

(51) Int. Cl. G03F 1/70; G06F 30/398

(52) U.S. Cl. CPC G03F 1/70; G06F 30/398; G06F 2119/18

(57) ABSTRACT

A design method of a photomask structure including the following steps is provided. A layout pattern is provided. The layout pattern includes first to third basic patterns. The second basic pattern is located between the first and third basic patterns and connected to the first and third basic patterns. There is a first jog portion between the first and second basic patterns, there is a second jog portion between the second and third basic patterns, and the first and second jog portions are located at two opposite sides of the layout pattern. The first and second jog portions are moved to align the first and second jog portions with each other and to eliminate the second basic pattern, wherein a first area change amount produced by moving the first jog portion is equal to a second area change amount produced by moving the second jog portion.

### CROSS-REFERENCE TO RELATED APPLICATION

This application claims the priority benefit of Taiwan application serial no. 112119466, filed on May 25, 2023. The entirety of the above-mentioned patent application is hereby incorporated by reference herein and made a part of this specification.

### BACKGROUND OF THE INVENTION

### Field of the Invention

The invention relates to a design method of a photomask structure, and in particular to a design method of a photomask structure that may effectively reduce shot count.

### Description of Related Art

In the current design method of a photomask, the layout pattern obtained after OPC is performed often has many jog portions. When the layout pattern has more jog portions, it will result in more shot counts during the manufacture of the photomask, thereby increasing the manufacturing time and the manufacturing cost of the photomask. Therefore, how to effectively reduce the shot count is the object of continuous effort.

### SUMMARY OF THE INVENTION

The invention provides a design method of a photomask structure that may effectively reduce shot count.

The invention provides a design method of a photomask structure including the following steps. A layout pattern is provided, wherein the layout pattern includes a plurality of basic patterns. The plurality of basic patterns include a first basic pattern, a second basic pattern, and a third basic pattern. The second basic pattern is located between the first basic pattern and the third basic pattern. The second basic pattern is connected to the first basic pattern and the third basic pattern. There is a first jog portion between the first basic pattern and the second basic pattern, there is a second jog portion between the second basic pattern and the third basic pattern, and the first jog portion and the second jog portion are located at two opposite sides of the layout pattern. The first jog portion and the second jog portion are moved to align the first jog portion and the second jog portion with each other and to eliminate the second basic pattern, wherein a first area change amount produced by moving the first jog portion is equal to a second area change amount produced by moving the second jog portion.

According to an embodiment of the invention, in the design method of the photomask structure, a relationship between the first area change amount and the second area change amount may be represented by the following formula 1.

$$W 1 \times D = W 2 \times ( L - D ) \qquad formula 1$$

A width of the first jog portion may be W1. A width of the second jog portion may be W2. Before the first jog portion and the second jog portion are aligned with each other, a distance between the first basic pattern and the third basic pattern may be L. After the first jog portion and the second jog portion are aligned with each other, the moving distance of the first jog portion may be D. The moving distance of the second jog portion may be a value obtained by subtracting the moving distance D from the distance L.

According to an embodiment of the invention, in the design method of the photomask structure, the moving distance D may be represented by the following formula 2.

$$D = \frac{W 2 \times L}{W 1 + W 2} \qquad formula 2$$

According to an embodiment of the invention, in the design method of the photomask structure, after the first jog portion and the second jog portion are aligned with each other, an area of the first basic pattern and an area of the third basic pattern may be increased, and the first basic pattern and the third basic pattern may be connected to each other.

According to an embodiment of the invention, in the design method of the photomask structure, the first basic pattern may include a first side and a second side. The second basic pattern may include a third side and a fourth side. The third basic pattern may include a fifth side and a sixth side. The second side may be overlapped with the third side. A length of the second side may be different from a length of the third side. The fourth side may be overlapped with the fifth side. A length of the fourth side may be different from a length of the fifth side.

According to an embodiment of the invention, in the design method of the photomask structure, after the first jog portion and the second jog portion are aligned with each other, the second side may be overlapped with the fifth side.

According to an embodiment of the invention, in the design method of the photomask structure, a width of the first jog portion may be greater than a width of the second jog portion.

According to an embodiment of the invention, in the design method of the photomask structure, a width of the first jog portion may be less than a width of the second jog portion.

According to an embodiment of the invention, in the design method of the photomask structure, a width of the first jog portion may be equal to a width of the second jog portion.

According to an embodiment of the invention, in the design method of the photomask structure, a shape of the first basic pattern may be a polygon.

According to an embodiment of the invention, in the design method of the photomask structure, a shape of the first basic pattern may be a rectangle.

According to an embodiment of the invention, in the design method of the photomask structure, a shape of the second basic pattern may be a polygon.

According to an embodiment of the invention, in the design method of the photomask structure, a shape of the second basic pattern may be a rectangle.

According to an embodiment of the invention, in the design method of the photomask structure, a shape of the third basic pattern may be a polygon.

According to an embodiment of the invention, in the design method of the photomask structure, a shape of the third basic pattern may be a rectangle.

Based on the above, in the design method of the photomask structure provided by the invention, the first jog portion and the second jog portion are moved to align the first jog portion and the second jog portion with each other and to eliminate the second basic pattern, wherein the first area change amount produced by moving the first jog portion is equal to the second area change amount produced by moving the second jog portion. Since the second basic pattern is eliminated, the number of basic patterns may be effectively reduced, thereby effectively reducing the number of shot count. In this way, the manufacturing time and the manufacturing cost of the photomask structure may be reduced.

Moreover, in the design method of the photomask structure provided by the invention, since the first area change amount produced by moving the first jog portion is equal to the second area change amount produced by moving the second jog portion, the production of new weak points may be prevented. In this way, additional photomask pattern repair is not needed, thereby reducing software and hardware costs and run time of photomask pattern repair.

In order to make the aforementioned features and advantages of the disclosure more comprehensible, embodiments accompanied with figures are described in detail below.

### BRIEF DESCRIPTION OF THE DRAWINGS

FIG. 1A to FIG. 1C are schematic top views of a design method of a photomask structure according to some embodiments of the invention.

FIG. 2 is a flowchart of a design method of a photomask structure according to some embodiments of the invention.

FIG. 3 is a schematic top view of a photomask structure according to some other embodiments of the invention.

FIG. 4 is a schematic top view of a photomask structure according to some other embodiments of the invention.

### DESCRIPTION OF THE EMBODIMENTS

Embodiments are provided hereinafter and described in detail with reference to figures. However, the embodiments provided are not intended to limit the scope of the invention. In order to facilitate understanding, the same components are described with the same reference numerals in the following description. In addition, the drawings are for illustration purposes only and are not drawn to original scale. In fact, the dimensions of the various features may be arbitrarily increased or reduced for clarity of discussion.

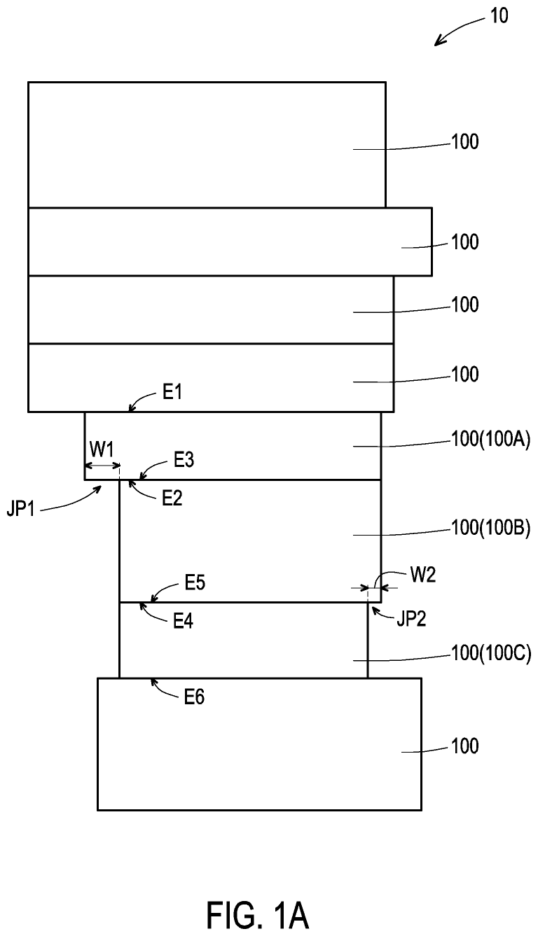

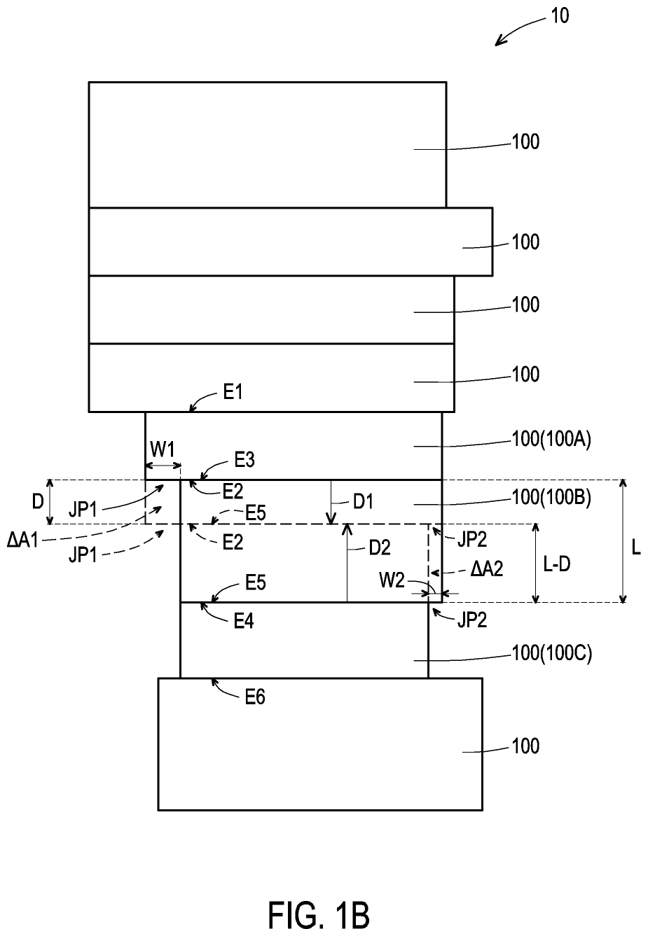

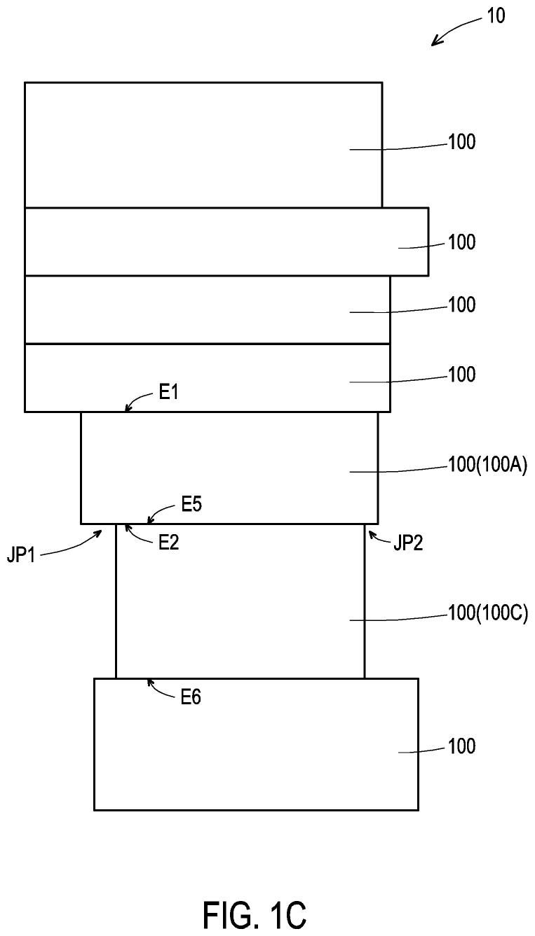

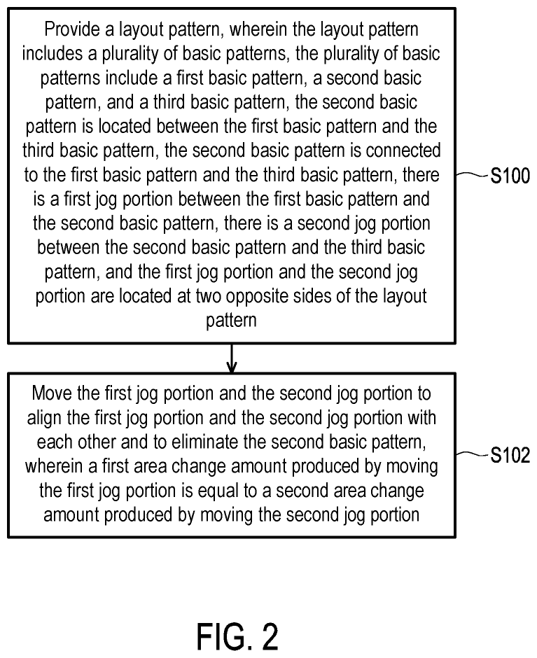

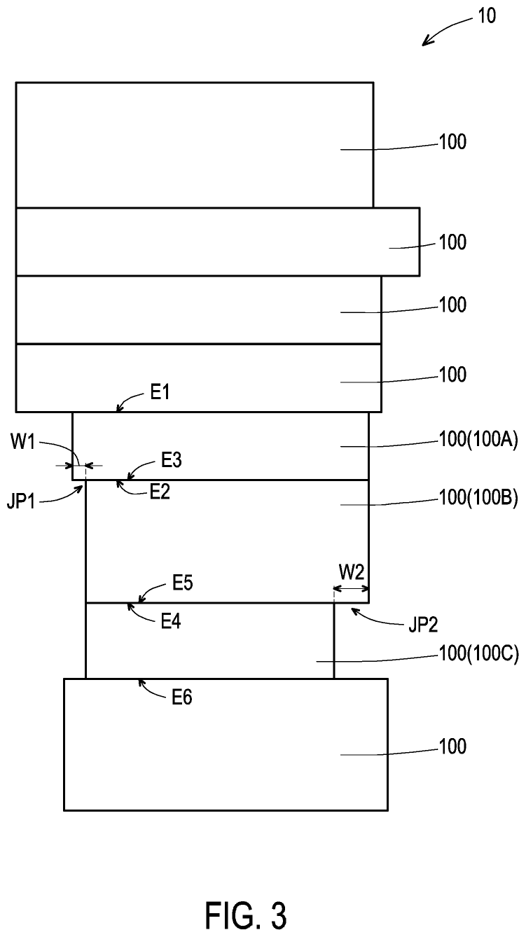

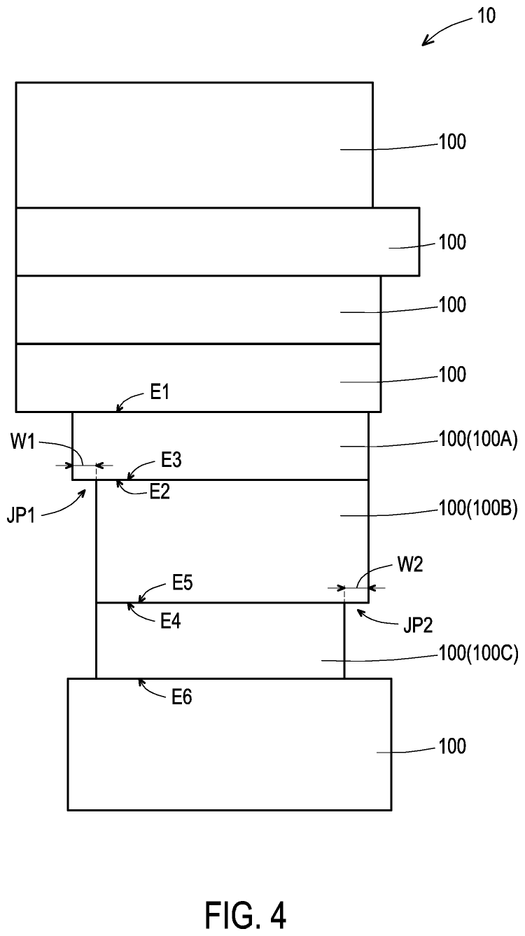

FIG. 1A to FIG. 1C are schematic top views of a design method of a photomask structure according to some embodiments of the invention. FIG. 2 is a flowchart of a design method of a photomask structure according to some embodiments of the invention. FIG. 3 is a schematic top view of a photomask structure according to some other embodiments of the invention. FIG. 4 is a schematic top view of a photomask structure according to some other embodiments of the invention.

Referring to FIG. 1A and FIG. 2, in step S100, a layout pattern 10 is provided, wherein the layout pattern 10 includes a plurality of basic patterns 100. The plurality of basic patterns 100 include a first basic pattern 100A, a second basic pattern 100B, and a third basic pattern 100C. The second basic pattern 100B is located between the first basic pattern 100A and the third basic pattern 100C. The second basic pattern 100B is connected to the first basic pattern 100A and the third basic pattern 100C. There is a first jog portion JP1 between the first basic pattern 100A and the second basic pattern 100B, there is a second jog portion JP2 between the second basic pattern 100B and the third basic pattern 100C, and the first jog portion JP1 and the second jog portion JP2 are located at two opposite sides of the layout pattern 10. In the layout pattern 10, two adjacent basic patterns 100 may be connected to each other. The layout pattern 10 may be a pattern on a photomask structure. In some embodiments, the photomask structure may be a binary mask or a phase shift mask (PSM), but the invention is not limited thereto. In addition, the shape of the layout pattern 10 may be determined according to product design, and is not limited to the shape shown in the figures. In addition, the number of the plurality of basic patterns 100 is not limited to the number in the figures. As long as the plurality of basic patterns 100 at least include the first basic pattern 100A, the second basic pattern 100B, and the third basic pattern 100C, it falls within the scope of the invention.

In some embodiments, the shape of the first basic pattern 100A may be a polygon. In some embodiments, the shape of the first basic pattern 100A may be a rectangle. In some embodiments, the shape of the second basic pattern 100B may be a polygon. In some embodiments, the shape of the second basic pattern 100B may be a rectangle. In some embodiments, the shape of the third basic pattern 100C may be a polygon. In some embodiments, the shape of the third basic pattern 100C may be a rectangle.

In some embodiments, the first basic pattern 100A may include a first side E1 and a second side E2. In some embodiments, the second basic pattern 100B may include a third side E3 and a fourth side E4. In some embodiments, the third basic pattern 100C may include a fifth side E5 and a sixth side E6. In some embodiments, the second side E2 may be overlapped with the third side E3, so that the first basic pattern 100A and the second basic pattern 100B may be connected to each other. In some embodiments, the length of the second side E2 and the length of the third side E3 may be different. In some embodiments, the fourth side E4 may be overlapped with the fifth side E5, so that the second basic pattern 100B and the third basic pattern 100C may be connected to each other. In some embodiments, the length of the fourth side E4 and the length of the fifth side E5 may be different.

In some embodiments, the width of the first jog portion JP1 may be W1. In some embodiments, the width of the second jog portion JP2 may be W2. In the present embodiment, as shown in FIG. 1A, the width W1 of the first jog portion JP1 may be greater than the width W2 of the second jog portion JP2, but the invention is not limited thereto. In some other embodiments, as shown in FIG. 3, the width W1 of the first jog portion JP1 may be less than the width W2 of the second jog portion JP2. In some other embodiments, as shown in FIG. 4, the width W1 of the first jog portion JP1 may be equal to the width W2 of the second jog portion JP2.

Referring to FIG. 1B, FIG. 1C, and FIG. 2, in step S100, the first jog portion JP1 and the second jog portion JP2 are moved to align the first jog portion JP1 and the second jog portion JP2 with each other and to eliminate the second basic pattern 100B (FIG. 1C), wherein a first area change amount AA1 produced by moving the first jog portion JP1 is equal to a second area change amount AA2 produced by moving the second jog portion JP2.

In step S100, the first jog portion JP1 may be moved along a direction D1, and the second jog portion JP2 may be moved along a direction D2. In some embodiments, the direction D1 may be toward the fifth side E5. In some embodiments, the direction D1 may be perpendicular to the second side E2. In some embodiments, the direction D2 may be toward the second side E2. In some embodiments, the direction D2 may be perpendicular to the fifth side E5.

In some embodiments, in the process of aligning the first jog portion JP1 with the second jog portion JP2, the second side E2 may be moved toward the fifth side E5 along the direction D1, and the fifth side E5 may be moved toward the second side E2 along the direction D2. In some embodiments, after the first jog portion JP1 and the second jog portion JP2 are aligned with each other, the second side E2 may be overlapped with the fifth side E5. As a result, after the first jog portion JP1 and the second jog portion JP2 are aligned with each other, the area of the first basic pattern 100A and the area of the third basic pattern 100C may be increased, and the first basic pattern 100A and the third basic pattern 100C may be connected to each other. Thereby, the second basic pattern 100B may be eliminated.

In some embodiments, the distance between the first basic pattern 100A and the third basic pattern 100C may be L before the first jog portion JP1 and the second jog portion JP2 are aligned with each other. In some embodiments, after the first jog portion JP1 and the second jog portion JP2 are aligned with each other, the moving distance of the first jog portion JP1 may be D. In some embodiments, the moving distance of the second jog portion JP2 may be a value obtained by subtracting the moving distance D from the distance L.

In some embodiments, the first area change amount AA1 may be a value obtained by multiplying the width W1 of the first jog portion JP1 by the moving distance D of the first jog portion JP1, and the second area change amount AA2 may be a value obtained by multiplying the width W2 of the second jog portion JP2 by the moving distance (e.g., the value obtained by subtracting the moving distance D from the distance L) of the second jog portion JP2. In this way, the relationship between the first area change amount AA1 and the second area change amount AA2 may be expressed by formula 1 below.

$$W 1 \times D = W 2 \times ( L - D ) \qquad formula 1$$

In addition, the moving distance D may be represented by formula 2 below.

$$D = \frac{W 2 \times L}{W 1 + W 2} \qquad formula 2$$

It may be known based on the above embodiments that, in the design method of the photomask structure, the first jog portion JP1 and the second jog portion JP2 are moved to align the first jog portion JP1 and the second jog portion JP2 with each other and to eliminate the second basic pattern 100B, wherein the first area change amount AA1 produced by moving the first jog portion JP1 is equal to the second area change amount AA2 produced by moving the second jog portion JP2. Since the second basic pattern 100B is eliminated, the number of the basic patterns 100 may be effectively reduced, thereby effectively reducing the number of shot count. In this way, the manufacturing time and the manufacturing cost of the photomask structure may be reduced.

Moreover, in the design method of the photomask structure of the above embodiments, since the first area change amount AA1 produced by moving the first jog portion JP1 is equal to the second area change amount AA2 produced by moving the second jog portion JP2, the production of new weak points may be prevented. In this way, additional photomask pattern repair is not needed, thereby reducing software and hardware costs and run time of photomask pattern repair.

Based on the above, in the design method of the photomask structure of the above embodiments, after the first jog portion and the second jog portion are aligned with each other, since the second basic pattern is eliminated, the number of basic patterns may be effectively reduced, and thus the number of shot count may be effectively reduced. In this way, the manufacturing time and the manufacturing cost of the photomask structure may be reduced.

Moreover, in the design method of the photomask structure of the above embodiments, since the first jog portion and the second jog portion are moved in such a manner that the first area change amount produced by moving the first jog portion is equal to the second area change amount produced by moving the second jog portion, the production of new weak points may be prevented. In this way, additional photomask pattern repair is not needed, thereby reducing software and hardware costs and run time of photomask pattern repair.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A design method of a photomask structure, comprising:
providing a layout pattern, wherein
the layout pattern comprises a plurality of basic patterns,
the plurality of basic patterns comprise a first basic pattern, a second basic pattern, and a third basic pattern,
the second basic pattern is located between the first basic pattern and the third basic pattern,
the second basic pattern is connected to the first basic pattern and the third basic pattern,
there is a first jog portion between the first basic pattern and the second basic pattern,
there is a second jog portion between the second basic pattern and the third basic pattern, and
the first jog portion and the second jog portion are located at two opposite sides of the layout pattern; and
moving the first jog portion and the second jog portion to align the first jog portion and the second jog portion with each other and to eliminate the second basic pattern, wherein a first area change amount produced by moving the first jog portion is equal to a second area change amount produced by moving the second jog portion.

2. The design method of the photomask structure of claim 1, wherein a relationship between the first area change amount and the second area change amount is represented by the following formula 1:
$$W 1 \times D = W 2 \times ( L - D ) \qquad formula 1$$
a width of the first jog portion is W1,
a width of the second jog portion is W2,
before the first jog portion and the second jog portion are aligned with each other, a distance between the first basic pattern and the third basic pattern is L, and
after the first jog portion and the second jog portion are aligned with each other, a moving distance of the first jog portion is D, and a moving distance of the second jog portion is a value obtained by subtracting the moving distance D from the distance L.

3. The design method of the photomask structure of claim 2, wherein the moving distance D is represented by the following formula 2:
$$D = \frac{W 2 \times L}{W 1 + W 2} \qquad formula 2$$

4. The design method of the photomask structure of claim 1, wherein after the first jog portion and the second jog portion are aligned with each other, an area of the first basic pattern and an area of the third basic pattern are increased, and the first basic pattern and the third basic pattern are connected to each other.

5. The design method of the photomask structure of claim 1, wherein
the first basic pattern comprises a first side and a second side,
the second basic pattern comprises a third side and a fourth side,
the third basic pattern comprises a fifth side and a sixth side,
the second side is overlapped with the third side,
a length of the second side is different from a length of the third side,
the fourth side is overlapped with the fifth side, and
a length of the fourth side is different from a length of the fifth side.

6. The design method of the photomask structure of claim 5, wherein after the first jog portion and the second jog portion are aligned with each other, the second side is overlapped with the fifth side.

7. The design method of the photomask structure of claim 1, wherein a width of the first jog portion is greater than a width of the second jog portion.

8. The design method of the photomask structure of claim 1, wherein a width of the first jog portion is less than a width of the second jog portion.

9. The design method of the photomask structure of claim 1, wherein a width of the first jog portion is equal to a width of the second jog portion.

10. The design method of the photomask structure of claim 1, wherein a shape of the first basic pattern comprises a polygon.

11. The design method of the photomask structure of claim 10, wherein a shape of the first basic pattern comprises a rectangle.

12. The design method of the photomask structure of claim 1, wherein a shape of the second basic pattern comprises a polygon.

13. The design method of the photomask structure of claim 12, wherein a shape of the second basic pattern comprises a rectangle.

14. The design method of the photomask structure of claim 1, wherein a shape of the third basic pattern comprises a polygon.

15. The design method of the photomask structure of claim 14, wherein a shape of the third basic pattern comprises a rectangle.
